(19) United States
(12) Patent Application Publication
(10) Pub. No.: US 2013/0335605 A1
(43) Pub. Date: Dec. 19, 2013

(54) IMAGE CAPTURE LENS ASSEMBLY AND IMAGE CAPTURE DEVICE THEREOF

(71) Applicant: Jui-Hsiung KUO, Kaohsiung City (TW)

(72) Inventor: Jui-Hsiung KUO, Kaohsiung City (TW)

(21) Appl. No.: 13/600,682

(22) Filed: Aug. 31, 2012

(30) Foreign Application Priority Data
Jun. 13, 2012 (TW) 101121183

(51) Int. Cl. G02B 15/14; H04N 5/335; G02B 17/08

(52) U.S. Cl. 348/294; 359/733; 359/689; 348/E05.091

(57) ABSTRACT

This invention discloses an image capture lens assembly and an image capture device thereof. The image capture lens assembly, sequentially on an optical axis, includes: a prism, a first lens-group, a second lens-group and a third lens-group. The prism is a full reflective lens. The first lens-group with negative refractive power includes at least one negative lens of the first lens-group, and at least one positive lens of the first lens-group. The second lens-group with positive refractive power comprises at least one positive lens of the second lens-group, and at least one negative lens of the second lens-group. The third lens-group with a positive refractive power comprises at least one lens of the third lens-group with at least one aspheric surface. By such arrangements, the invention can effectively correct aberrations and be applied to compact lens modules.

### CROSS-REFERENCE TO RELATED APPLICATION

This application claims the benefit of Taiwan Patent Application No. 101121183, filed on Jun. 13, 2012, in the Taiwan Intellectual Property Office, the disclosure of which is incorporated herein in its entirety by reference.

### BACKGROUND OF THE INVENTION

1. Field of the Invention

The present invention relates to an image capture lens assembly and an image capture device thereof, and more particularly to the image capture lens assembly and the image capture device, comprised of a prism and three lens groups so as to be applied to compact lens modules.

2. Description of Related Art

Compact electronic devices such as digital still cameras, mobile phone cameras, and web cameras are generally installed with a periscopic image capture lens assembly for capturing an image of an object, and the image capture lens assembly tends to be developed with a compact design and a low cost, and manufacturers attempt to manufacture image capture lens assemblies with good aberration correction ability, high resolution and high image quality.

In most conventional image capture lens assemblies, an additional lens having a concave surface at an image side thereof or an additional crescent-shaped lens having a convex surface at an object side thereof is arranged to provide better light gathering power. Therefore, an additional lens is required, thus having the drawbacks of failing to reduce the volume of the lens assembly and incurring a higher cost. In addition, in order to provide better light-gathering ability, the curvature variation at the concave optical surface may be too substantial, thus making the manufacture relatively more difficult and increasing the cost further. To overcome the aforementioned drawbacks, a better design is required to provide a better compensation for aberrations and limit the total length of the image capture lens assembly in order to be applied to a compact image capture device. The present invention provides a more practical design and adopts a combination of the refractive power, convex surfaces and concave surfaces of lenses of three groups to achieve high imaging quality, easy mass production and feasible applications in compact image capture devices.

In view of the aforementioned problems, the inventor of the present invention based on years of experience in the related industry to conduct extensive researches and experiments, and finally developed an image capture lens assembly and an image capture device thereof to overcome the problems of the prior art and improve industrial applications.

### SUMMARY OF THE INVENTION

In order to improve the above-mentioned problems of prior art, the primary objective of the present invention is to provide an image capture lens assembly and an image capture device capable of lowering the cost and miniaturizing the image capture assembly and device.

To achieve the aforementioned objective, the present invention provides an image capture lens assembly, sequentially on an optical axis, comprising a prism, a first lens-group, a second lens-group and a third lens-group. The prism is a total reflection prism. The first lens-group with negative refractive power comprises at least one negative lens of the first lens-group and at least one positive lens of the first lens-group. The second lens-group with positive refractive power comprises at least one positive lens of the second lens-group and at least one negative lens of the second lens-group. The third lens-group with positive refractive power comprises at least one lens of the third lens-group, and at least one lens of the third lens-group has an aspheric surface.

Preferably, the prism may be a lens disposed nearest to an object to be photographed and have an incident optical surface, a reflective surface and an exit optical surface.

Preferably, the reflective surface may be a mirror surface.

Preferably, the reflective surface may have a total reflection coating.

Preferably, the image capture lens assembly may perform a zooming function when the first lens-group and the second lens-group produce an axial displacement along the optical axis

Preferably, the image capture lens assembly may further comprise an aperture which is a middle aperture disposed between the first lens-group and the second lens-group.

To achieve the aforementioned objective, the present invention further provides an image capture device, sequentially on an optical axis, comprising: a prism, a first lens-group, a second lens-group, a third lens-group and an image sensor. The prism is a total reflection prism. The first lens-group with negative refractive power comprises at least one negative lens of the first lens-group and at least one positive lens of the first lens-group. The second lens-group with positive refractive power comprises at least one positive lens of the second lens-group and at least one negative lens of the second lens-group. The third lens-group with positive refractive power comprises at least one lens of the third lens-group, and at least one lens of the third lens-group has an aspheric surface. The image sensor is installed on an image plane of the image capture device so as to capture the image of an object.

Preferably, the prism may be a lens disposed nearest to the object to be photographed, and have an incident optical surface, a reflective surface and an exit optical surface.

Preferably, the reflective surface may be a mirror surface.

Preferably, the reflective surface may have a total reflection coating.

Preferably, the image capture lens assembly may perform a zooming function when the first lens-group and the second lens-group produce an axial displacement along the optical axis.

Preferably, the image capture lens assembly may further comprise an aperture which is a middle aperture disposed between the first lens-group and the second lens-group.

In summation, the image capture lens assembly and the image capture device of the present invention have one or more of the following advantages:

(1) The image capture lens assembly and the image capture device of the present invention can reflect the light of an image of an object to be photographed by a total reflection prism to achieve the effect of miniaturizing the image capture lens assembly and the image capture device.

(2) The image capture lens assembly and the image capture device of the present invention comprises the prism, the first lens-group, the second lens-group and the third lens-group installed on an optical axis and at positions with an appropriate interval apart from one another to achieve the effect of a good aberration correction and an advantageous modulation transfer function (MTF), and effectively reduce the total length of the image capture lens assembly or the total length of the lenses of the image capture device.

### BRIEF DESCRIPTION OF THE DRAWINGS

FIG. 1 is a schematic view of an image capture lens assembly in accordance with the present invention;

FIG. 2 is a first schematic view of an image capture device in accordance with the present invention;

FIG. 3 is a second schematic view of an image capture device in accordance with the present invention;

FIG. 4 is a third schematic view of an image capture device in accordance with the present invention;

FIG. 5 is a fourth schematic view of an image capture device in accordance with the present invention;

FIG. 6 is an astigmatism curve of an image capture device in accordance with the present invention;

FIG. 7 is a distortion curve of an image capture device in accordance with the present invention;

FIG. 8 is a longitudinal spherical aberration curve of an image capture device in accordance with the present invention;

FIG. 9 is a lateral color curve of an image capture device in accordance with the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, the drawings are not necessarily drawn in actual scale or ratio, and same numerals are used in the following preferred embodiment to represent respective same elements. It is noteworthy that the drawings are provided for the purpose of illustrating the present invention, but not intended for limiting the scope of the invention.

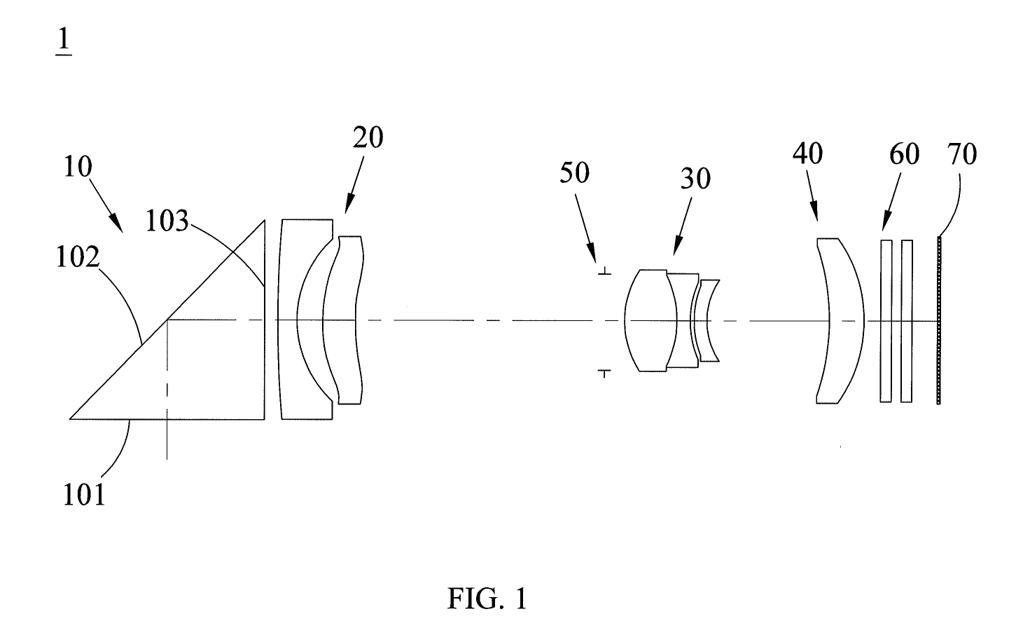

With reference to FIG. 1 for a schematic view of an image capture lens assembly in accordance with the present invention, the image capture lens assembly 1 is applicable to an image capture lens of a digital camera, particularly applicable to a periscopic image capture lens. The image capture lens assembly 1, sequentially on an optical axis, comprises a prism 10, a first lens-group 20, a second lens-group 30 and a third lens-group 40. The first lens-group 20 with negative refractive power comprises at least one negative lens of the first lens-group and at least one positive lens of the first lens-group. The second lens-group 30 with positive refractive power comprises at least one positive lens of the second lens-group and at least one negative lens of the second lens-group. The third lens-group 40 with positive refractive power comprises at least one lens of the third lens-group, and at least one lens of the third lens-group has at least one aspheric surface. The image capture lens assembly 1 further comprises an aperture 50 and at least one filter 60. The aperture 50 is disposed between the first lens-group 20 and the second lens-group 30, and the filter 60 is preferably an infrared filter (IR-filter) installed between the third lens-group 40 and an image plane 70, and the filter 60 generally made of a sheet optical material without affecting the focal length of the image capture lens assembly 1.

Wherein, the prism 10 has an incident surface 101, a reflective surface 102 and an exit surface 103, and the reflective surface 102 is a mirror surface having a total reflection coating. When the light of an image of an object to be photographed enters from the incident surface 101 into the image capture lens assembly 1, the light is totally reflected by the reflective surface 102 and directed to and exited from the exit surface 103, and the light passes through the first lens-group 20, the second lens-group 30, the third lens-group 40 and the filter 60 sequentially to form an image on an image plane 70. Wherein, the prism 10 may be a right-angled triangular prism, and the reflective surface 102 may be disposed on the hypotenuse of the right-angled triangular prism.

It is noteworthy that each lens of the image capture lens assembly 1 can be made of glass or plastic. For plastic lenses, the production cost can be lowered effectively. For glass lenses, the refractive power of the image capture lens assembly 1 can be used flexibly. In addition, the optical surface of the lens can be an aspheric surface to facilitate an easy manufacture in other shapes except the spherical surface and have a better control on variables, so as to reduce and eliminate aberrations and reduce the number of required lenses. Therefore, the total length of the image capture lens assembly 1 of the present invention can be decreased effectively. In the image capture lens assembly 1 of the present invention, at least one aperture stop such as a glare stop or a field stop can be installed to reduce stray lights and enhance image quality.

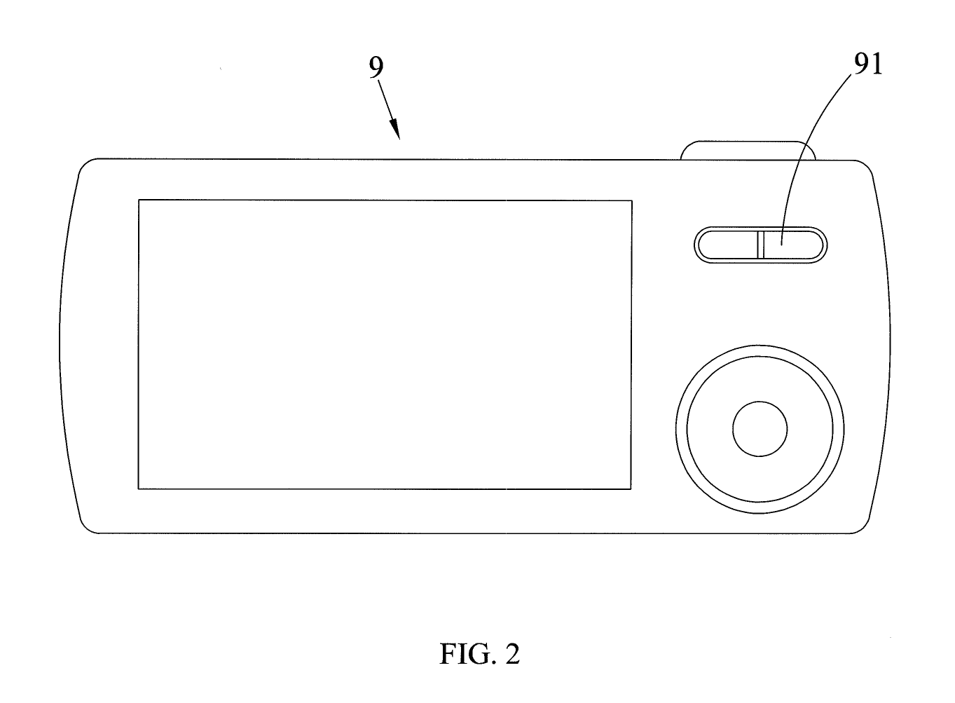

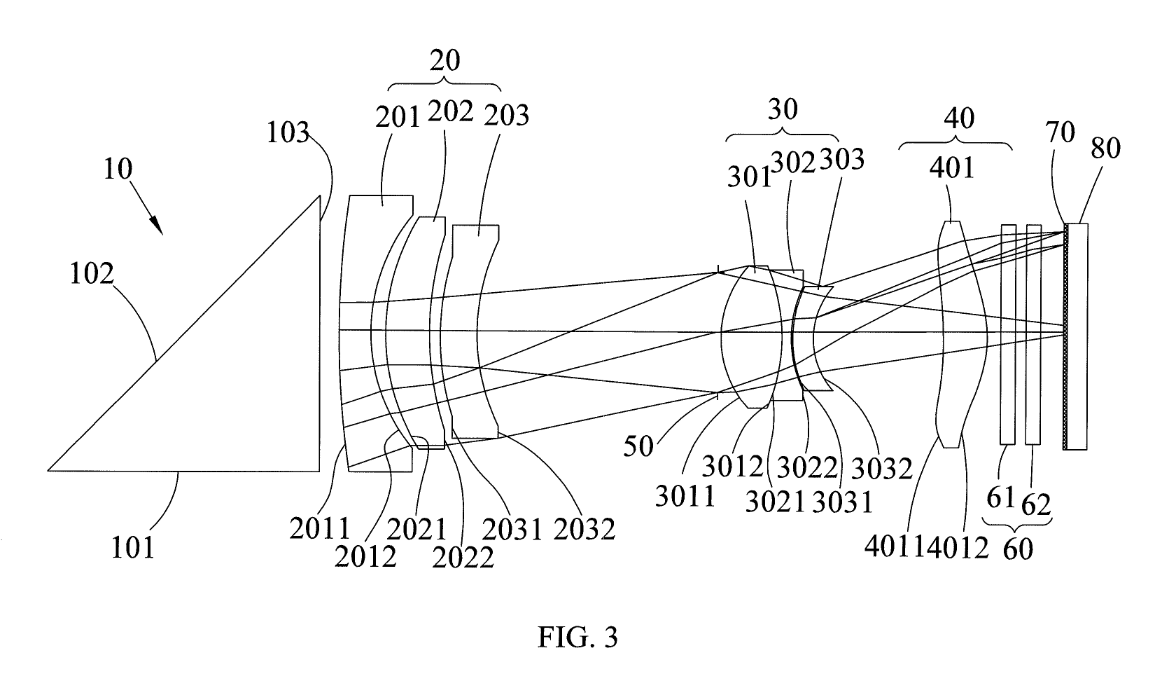

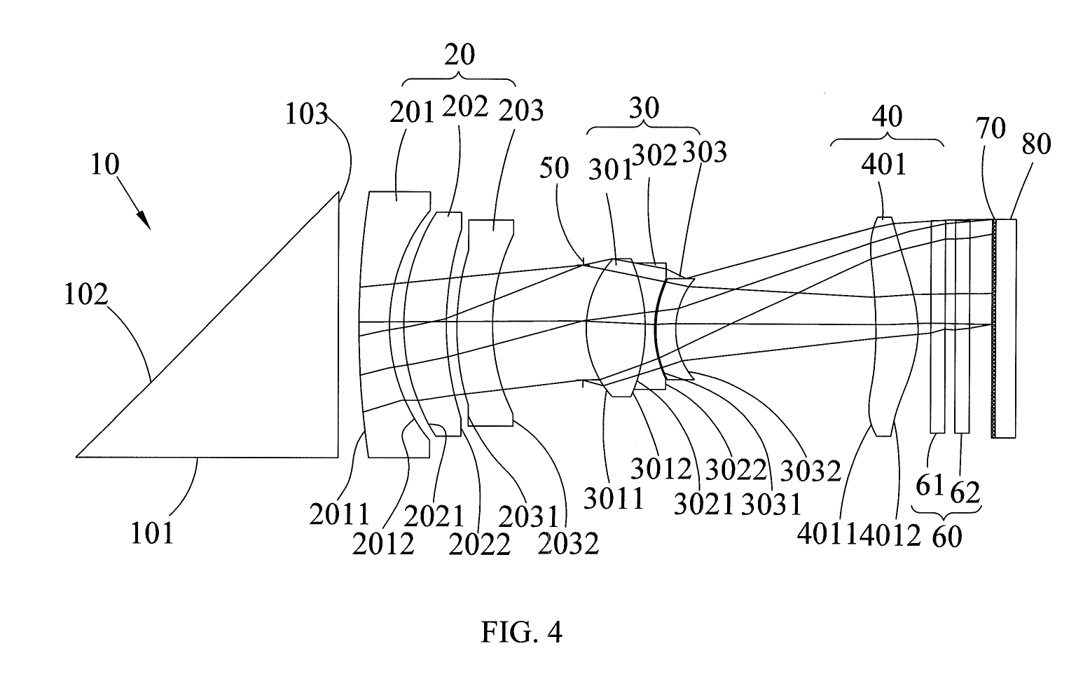

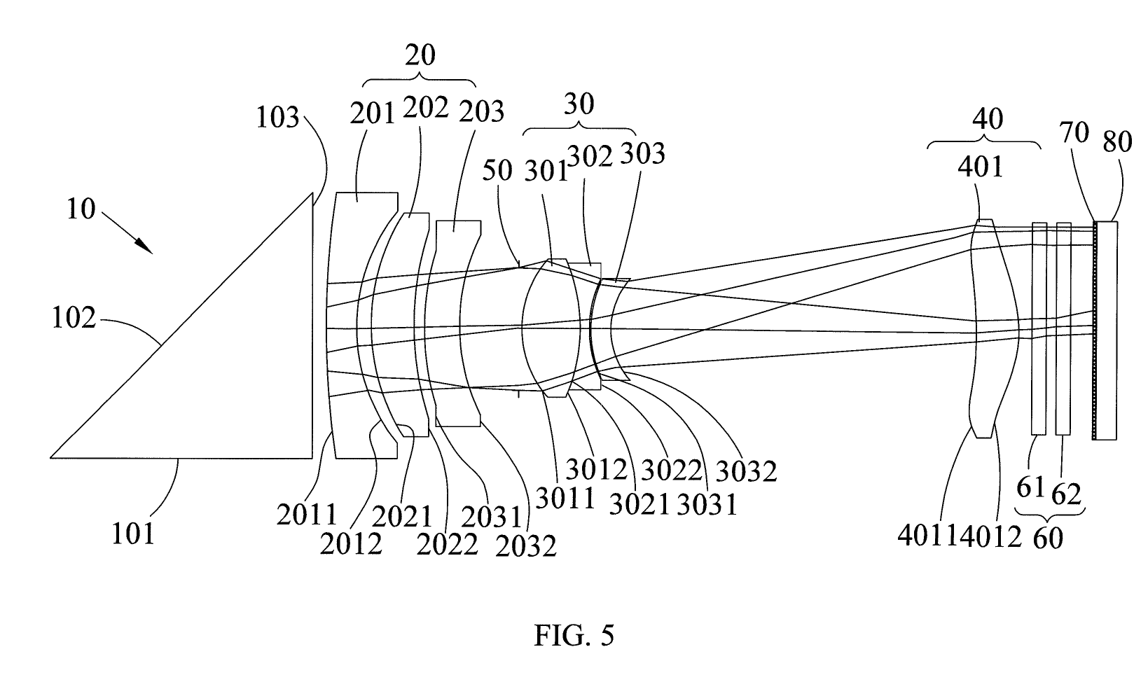

With reference to FIGS. 2 to 5 for a preferred embodiment, the portions of this preferred embodiment identical or similar to those described above will not be repeated. In the figures, the image capture lens of the image capture device 9 is an image capture lens assembly 1 comprising a prism 10, a first lens-group 20, a second lens-group 30, a third lens-group 40, an aperture 50, a filter 60 and an image sensor 80. The first lens-group 20 is a lens group with negative refractive power and on an optical axis comprising: a first negative lens 201 having negative refractive power of the first lens-group 20, wherein the first optical surface 2011 of the first negative lens 201 is convex, and the second optical surface 2012 of the first negative lens 201 is concave; a positive lens 202 having positive refractive power of the first lens-group 20, wherein the first optical surface 2021 of the positive lens 202 is convex and the second optical surface 2022 of the positive lens 202 is concave; a second negative lens 203 having negative refractive power of the first lens-group 20, wherein the first optical surface 2031 of the second negative lens 203 is an aspheric convex surface, and the second optical surface 2032 of the second negative lens 203 is an aspheric concave surface. The second lens-group 30 is a lens group with positive refractive power, and sequentially on an optical axis, comprising: a positive lens 301 having positive refractive power of the second lens-group 30, wherein the first optical surface 3011 of the positive lens 301 is convex and the second optical surface 3012 of the positive lens 301 is convex; a first negative lens 302 having negative refractive power of the second lens-group 30, wherein the first optical surface 3021 and the second optical surface 3022 of the first negative lens 302 are both concave; a second negative lens 303 having negative refractive power of the second lens-group 30, wherein the first optical surface 3031 of the second negative lens 303 is an aspheric convex surface, and the second optical surface 3032 of the second negative lens 303 is an aspheric concave surface. The third lens-group 40 is a lens group with positive refractive power, sequentially on an optical axis, comprising: a lens 401 having positive refractive power of the third lens-group 40, wherein the first optical surface 4011 of the lens 401 is an aspheric concave surface, and the second optical surface 4012 of the lens 401 is an aspheric convex surface. In this preferred embodiment, the filter 60 may comprise a first filter 61 and a second filter 62, made of sheet glass and provided for adjusting the wavelength range of the light of the image. Wherein, the image sensor 80 is installed on an image plane 70, so that the light of an image of an object to be photographed passes through a combination of the three lens groups, the aperture 50 and the filter 60 to form an image on the image sensor 80.

With reference to Table 1 for optical data of this preferred embodiment, the image capture device 9 may further comprise a processing module, a storage module, a power supply module, a zoom driving module (such as a zooming mechanism and a zooming motor) and other conventional components of this area. After a user presses a zoom button 91 (such as a wide-angle or telescope button), the zoom driving module is driven to move the first lens-group 20 and the second lens-group 30, so as to change the relative distance between the first lens-group 20 and the second lens-group 30 or the relative distance between the first lens-group 20 and the second lens-group 30 and the prism 10 or the third lens-group 40 to achieve the zooming effect. In Table 1, the effective focal length value of this preferred embodiment is f=4.1˜7.1˜12.3 (mm), which constitutes the aperture value aperture (f-number) Fno=3.1˜4.2˜6. In other words, if the first lens-group 20 is disposed at a position with a distance of 0.3 and 7.644 from the prism 10 and the second lens-group 30 respectively and the distance between the second lens-group 30 and the third lens-group 40 is 2.8, then it is considered as a wide-angle end; and if the first lens-group 20 is disposed at a distance of 0.38 and 1.8 from the prism 10 and the second lens-group 30 respectively, and the distance between the second lens-group 30 and the third lens-group 40 is 8.804, then it is considered as a telescopic end. In other words, if f=4.1, then A=0.3, B=7.644 and C=2.8; if f=7.1, then A=1.8, B=4.036 and C=5.138; and if f=12.3, then A=0.38, B=1.8 and C=8.804.

In addition, the first lens-group 20 of this preferred embodiment adopts negative refractive power to increase the angular field of view. The first lens-group 20 combined with the second lens-group 30 with positive refractive power can increase the magnification of the image and improve the resolution of the image. The third lens-group 40 adopts positive refractive power to effectively compensate the aberrations produced by the first lens-group 20 and the second lens-group 30, such that the aberrations and distortions can comply with the resolution requirements.

TABLE 1
Optical Data of This Preferred Embodiment
f = 4.1~7.1~12.3 mm, Fno = 3.1~4.2~6

| | | | | | Coefficient |
|---|---|---|---|---|---|
| Optical | | Radius of | Thickness or | Refractive | of |
| Surface | | Curvature | Distance | Index | dispersion |
| 0 | Object to be | | | | |
| | photographed | | | | |
| 1 | Incident surface | ∞ | 7.5 | 1.85 | 23.8 |
| | of the prism | | | | |
| 2 | Reflective | ∞ | 7.5 | 1.85 | 23.8 |
| | surface of the | | | | |
| | prism | | | | |
| 3 | Exit surface of | ∞ | 0.3~1.8~0.38 | | |
| | the prism | | | | |
| 4 | First negative | 34.768 | 0.6 | 1.729 | 54.680 |
| 5 | lens of the first | 3.97 | 0.311 | | |
| | lens-group | | | | |
| 6 | Positive lens of | 4.363 | 1 | 1.607 | 26.992 |
| 7 | the first | 8.122 | 0.194 | | |
| | lens-group | | | | |
| 8 | Second negative | 4.165 (ASP) | 0.85 | 1.534 | 55.994 |
| 9 | lens of the first | 3.434 (ASP) | 7.644~4.036~1.8 | | |
| | lens-group | | | | |
| 10 | Aperture | ∞ | 0.1 | | |
| 11 | Positive lens of | 2.373 | 1.5 | 1.816 | 46.620 |
| 12 | the second | −3.355 | 0.005 | 1.560 | 55.000 |
| | lens-group | | | | |
| 13 | First negative | −3.355 | 0.4 | 1.698 | 30.127 |
| 14 | lens of the second | 2.515 | 0.1 | | |
| | lens-group | | | | |
| 15 | Second negative | 1.883 (ASP) | 0.4 | 1.534 | 55.994 |
| [symbol] | lens of the second | [symbol] | [symbol] | [symbol] | [symbol] |

[symbol]

indicates data missing or illegible when filed

Wherein, the aspheric surfaces of the lens groups satisfy the conditions of the aspherical surface formula, wherein the related aspheric surface coefficients are listed in Table 2, and the aspheric surface formula is well known to those skilled in the art, and thus will not be described.

TABLE 2
Aspheric Coefficients of This Preferred Embodiment
Aspheric Coefficients

| | Surface # | | | | |
|---|---|---|---|---|---|
| | 8 | 9 | 15 | 16 | 17 |
| k = | 1.505 | 0.02 | −0.078 | 0.406 | 0.214 |
| A4 = | −0.016 | −0.0181 | −0.0734 | −0.0686 | 0.0213 |
| A6 = | 0.000463 | 0.000685 | −0.0570 | −0.0343 | −0.000425 |
| A8 = | −0.000369 | −0.000275 | 0.0344 | −0.0163 | −6.67 |
| A10 = | 5.84e−005 | 2.182 | −0.0384 | 0.00986 | 1.435 |
| A12 = | −6e−006 | | 0.0161 | 0.000673 | |

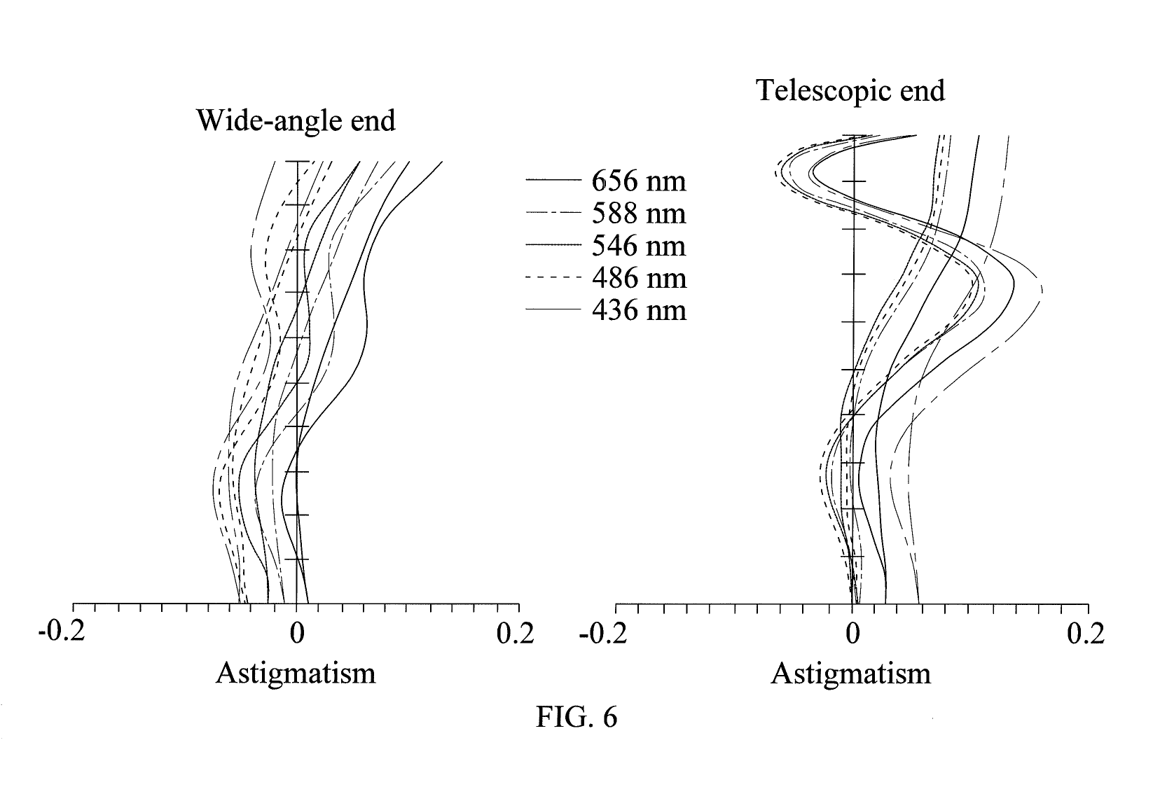

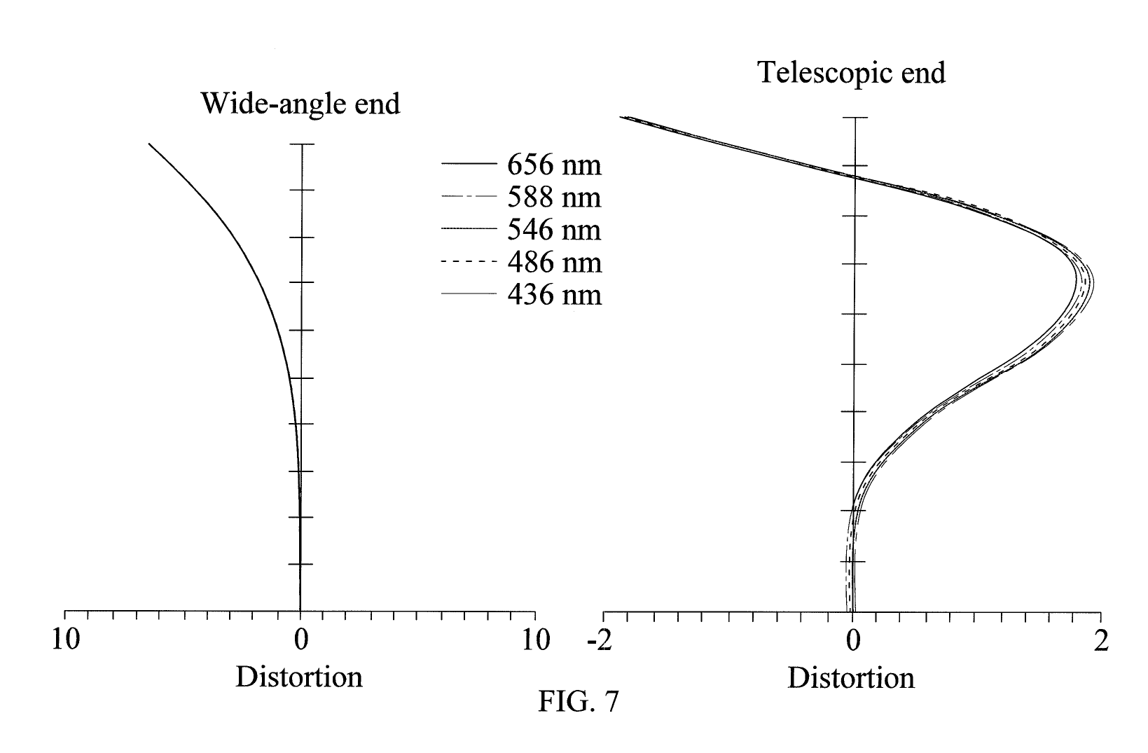

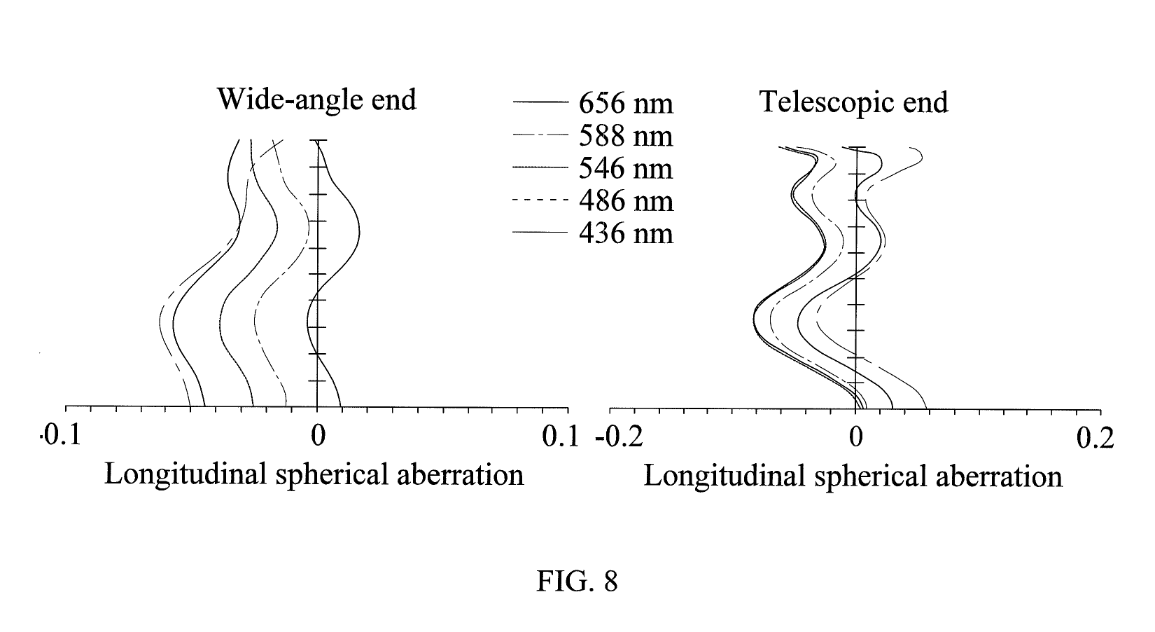

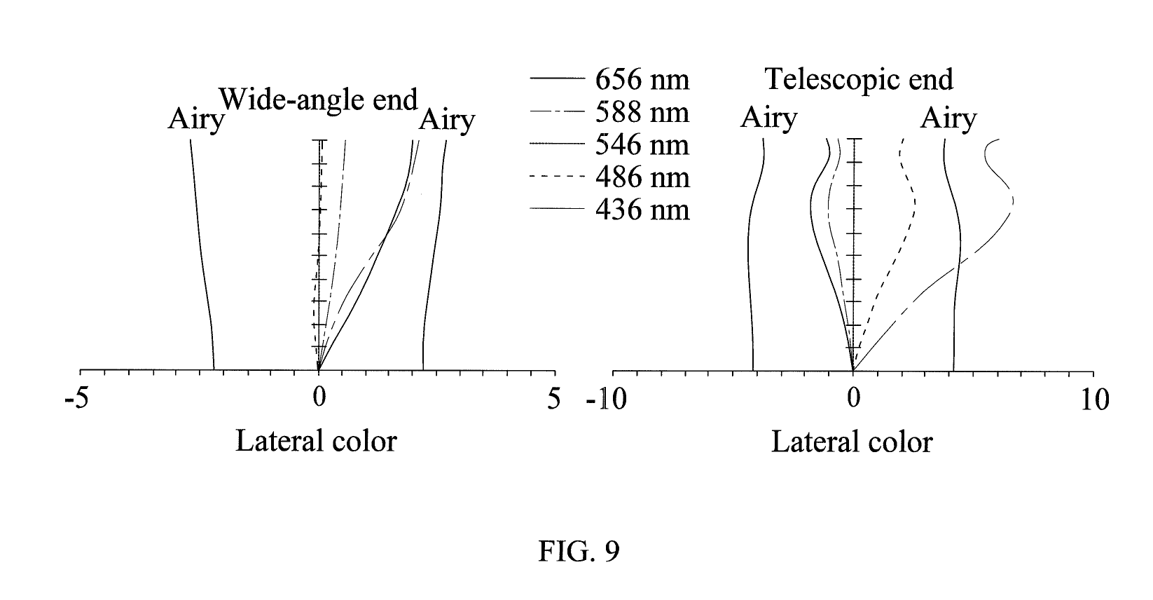

According to the optical data as shown in Table 1 and the curves as shown in FIGS. 6 to 9, the image capture lens assembly and the image capture device of the present invention provides good correction results in aspects of the field curving, distortion, longitudinal spherical aberration, and lateral color.

In the image capture lens assembly and the image capture device of the present invention, if the lens surface is convex, then the lens surface is convex at a position near the optical axis; and if the lens surface is concave, then the lens surface is concave at a position near the optical axis.

Tables 1 and 2 are tables showing the change of values of the image capture lens assembly and the image capture device of preferred embodiments of the present invention, and even if different values are used, product of the same structure are intended to be covered by the scope of the present invention. It is noteworthy to point out that the aforementioned description and the illustration of related drawings are provided for the purpose of explaining the technical characteristics of the present invention, but not intended for limiting the scope of the present invention.

What is claimed is:

1. An image capture lens assembly, sequentially on an optical axis, comprising:
a prism, being a total reflection prism;
a first lens-group, with negative refractive power, comprising at least one negative lens of the first lens-group and at least one positive lens of the first lens-group;
a second lens-group, with positive refractive power, comprising at least one positive lens of the second lens-group and at least one negative lens of the second lens-group; and
a third lens-group, with positive refractive power, comprising at least one lens of the third lens-group, and the at least one lens of the third lens-group having at least one aspheric surface.

2. The image capture lens assembly of claim 1, wherein the prism is a lens disposed to be close to an object to be photographed, and having an incident optical surface, a reflective surface and an exit optical surface.

3. The image capture lens assembly of claim 2, wherein the reflective surface is a mirror surface.

4. The image capture lens assembly of claim 3, wherein the reflective surface has a total reflection coating.

5. The image capture lens assembly of claim 1, wherein the image capture lens assembly performs a zooming function when the first lens-group and the second lens-group produce an axial displacement along the optical axis.

6. The image capture lens assembly of claim 1, further comprising an aperture which is a middle aperture disposed between the first lens-group and the second lens-group.

7. An image capture device, sequentially on an optical axis, comprising:
a prism, being a total reflection prism;
a first lens-group, with negative refractive power, comprising at least one negative lens of the first lens-group and at least one positive lens of the first lens-group;
a second lens-group, with positive refractive power, comprising at least one positive lens of the second lens-group and at least one negative lens of the second lens-group;
a third lens-group, with positive refractive power, comprising at least one lens of the third lens-group, and the at least one lens of the third lens-group having at least one aspheric surface; and
an image sensor, installed on an image plane of the image capture device for imaging an object to be photographed.

8. The image capture device of claim 7, wherein the prism is a lens disposed nearest to the object to be photographed, and having an incident optical surface, a reflective surface and an exit optical surface.

9. The image capture device of claim 8, wherein the reflective surface is a mirror surface.

10. The image capture device of claim 9, wherein the reflective surface has a total reflection coating.

11. The image capture device of claim 7, wherein the image capture lens assembly performs a zooming function when the first lens-group and the second lens-group produce an axial displacement along the optical axis.

12. The image capture device of claim 7, further comprising an aperture which is a middle aperture disposed between the first lens-group and the second lens-group.
